(19) United States
(12) Patent Application Publication
(10) Pub. No.: US 2017/0284529 A1
(43) Pub. Date: Oct. 5, 2017

(54) TOOTHING OF A GEARWHEEL

(71) Applicant: Volth Patent GmbH, Heidenheim (DE)

(72) Inventors: Lars Schneider, Dresden (DE); Zsolt Roth, Heidenheim (DE); Michael Münzer, Dresden (DE); Florian Lubos, Herbrechtingen (DE)

(73) Assignee: Volth Patent GmbH, Heidenheim (DE)

(21) Appl. No.: 15/624,781

(22) Filed: Jun. 16, 2017

Related U.S. Application Data
(62) Division of application No. 14/858,440, filed on Sep. 18, 2015.
Application No. 14/858,440 is a continuation of application No. PCT/EP2014/054110, filed on Mar. 4, 2014.

(30) Foreign Application Priority Data
Mar. 21, 2013 (DE) 10 2013 004 861.3

(51) Int. Cl. F16H 55/08

(52) U.S. Cl. CPC F16H 55/08; F16H 55/0886

(57) ABSTRACT

The invention includes a toothing of a gearwheel having a plurality of teeth, the tooth flanks of which have a main region and a tooth root region. The tooth root region extends from a root circle (FP) as far as a main circle (d_{H}), as considered in the end section or normal section through the axis of rotation of the gearwheel. As considered in each case in the end section or normal section, the tooth flanks in the tooth root region are designed as a Bézier curve from a relevant diameter (dᵣ) in the direction of the tooth root. The Bézier curve merges in each case at a main point (P₀, P₃) in the relevant diameter (dᵣ) in a continuous tangent into the tooth profile of the main region.

### CROSS REFERENCE TO RELATED APPLICATIONS

This is a division of U.S. patent application Ser. No. 14/858,440, entitled “TOOTHING OF A GEARWHEEL”, filed Sep. 18, 2015, which is incorporated herein by reference. U.S. patent application Ser. No. 14/858,440 is a continuation of PCT application No. PCT/EP2014/054110, entitled “TOOTHING OF A GEARWHEEL”, filed Mar. 4, 2014, which is incorporated herein by reference.

### BACKGROUND OF THE INVENTION

### 1. Field of the Invention

The invention relates to the toothing of a gearwheel having a plurality of teeth.

### 2. Description of the Related Art

From DE 10 2006 015 521 B3 the toothing of an involute hobbed toothed gearwheel is known. The substance of the document deals with the so-called “tooth root region” the region that connects the individual teeth of the involute hobbed toothed gearwheel. With the objective to provide equally runnable toothing in both running directions, a tooth root region is suggested in the referred-to document which—when compared with the conventional hobbed fillet—is rounded in the form of an ellipse. These types of gearwheels offer greater load rating due to the elliptical rounding of the tooth root region, than do gearwheels having a radial rounding.

DE 10 2008 045 318 B3 describes a toothing of a gearwheel as the closest prior art, whose tooth root region is composed of several curves that can be described by mathematical functions. First, a region in the form of a tangent function follows the tooth profile from the point of a relevant diameter. Subsequently this merges into a circular path in order to again in a tangent function merge into the tooth profile on the opposite side.

This progression—in as far as it is manufactured precisely—has proven to be advantageous in regard to tensions. It does however have one disadvantage; the computing effort increases in the design of the gearwheel since the parameters for the precise positioning of the curves relative to each other—for example, the position of the merge from the tangent function to the circular path—must be precisely calculated.

### SUMMARY OF THE INVENTION

The current invention provides toothing for a hobbed toothed gearwheel that avoids the aforementioned disadvantages.

The toothing of a gearwheel according to the invention includes a plurality of teeth whose tooth flanks have a main region and a tooth root region. The tooth root region extends from a root circle as far as a main circle as considered in the face section or normal section, parallel to the axis of rotation of the gearwheel from.

If mention is made in the current invention to radius, circle or diameter, then the relevant diameter related to the axis of rotation of the inventively toothed gearwheel is always meant for its description. The inventive toothing can hereby be designed as internal toothing or external toothing. The relevant diameter is always cited relative to the axis of rotation of the toothed gearwheel, regardless of whether an internal toothing or an external toothing is present.

In terms of the current invention the term of “face section” is to be understood to be a section through the gearwheel, vertical relative to the axis of rotation. “Normal section” in contrast is to be understood to be a section through the gearwheel, vertical to a flank line progressing in longitudinal extension of the toothing. For example, in the case of a helical toothing the construction of the root contour can be manufactured in the face section. Subsequently, the toothing that has to be produced for the required tool, for example the hobbing tool, can be transformed in the normal section. A reversed procedure is in principle also conceivable.

In terms of the current invention the main region is that section of the toothing that is located between the tip circle in the region of the tips of the teeth and the main circle d_{H}, viewed in the aforementioned section. Thus, in the case of the external toothing the root tooth region adjoins radially inside the main circle d_{H}, in particular directly to the main region. Similarly, in the case of internal toothing this adjoins radially outside of the main circle d_{H}. If no protuberance is provided in the toothing then the main region is consistent with a useful region. The useful region defines the region that progresses from the tip circle to a diameter d_{N}. In the useful region the tooth flanks of the gearwheel and the respective counter gearwheel roll off one another. In contrast, when providing a protuberance the main region in addition to the useful region comprises a protuberance region, wherein the protuberance is arranged. In the case of external toothing the protuberance region progresses between the useful circle d_{N} and a protuberance circle d_{P} that is arranged radially inside the useful circle d_{N}. In the case of internal toothing the protuberance region progresses between the useful circle d_{N} and a protuberance circle d_{P} arranged radially outside the useful circle d_{N}. The protuberance circle d_{P} results geometrically from the selected protuberance profile of the protuberance. In the case of external toothing the protuberance circle d_{P} can for example be characterized by the circle to the radially innermost point and in the case of internal toothing by the circle to the radially outermost point of the protuberance profile. When providing a protuberance, the main circle d_{H} therefore coincides with the protuberance circle d_{P} that—relative to the useful circle d_{N} is positioned radially further toward the inside (in the case of external toothing) or radially toward the outside (in the case of internal toothing). In summarizing it can be stated that—regardless of internal or external toothing—without protuberance the main circle extends from the tip circle to the useful circle d_{N}, and with protuberance from the tip circle to the protuberance circle d_{P}.

The transition from the tooth root region into the main region—viewed from the tooth root region—occurs according to the invention in a relevant diameter dᵣ. In terms of the current invention the relevant diameter dᵣ can be selected so that it coincides with the main circle. For the case where no protuberance is provided the main circle—as described above—is consistent with the useful region, so that the relevant diameter dᵣ is consistent with the main circle d_{H} and thus consistent with the useful circle d_{N}. Generally, in the case of external toothing the relevant diameter dᵣ is selected to be somewhat smaller and in the case of internal toothing somewhat larger than the respective useful circle d_{N}, in order to ensure practical reliability in regard to the manufacturing tolerances and the mounting tolerance of the gearwheels. In the case of a protuberance it is consistent with the protuberance circle d_{P} or—as indicated in the example regarding internal and external toothing—is selected somewhat smaller or larger than the relevant protuberance circle d_{P}, also by ensuring a practical reliability.

According to the invention the tooth flanks in the tooth root region are designed as a Bézier curve—viewed in each case from the face section or normal section—starting from the relevant diameter dᵣ in the direction toward the root circle. In the case of external toothing “in direction toward the root circle” means in particular, in the radial direction toward the gearwheel central point; and in the case of internal toothing means in particular, in the radial direction away from the gearwheel central point toward the outside. The Bézier curve merges in each case at a main point in the relevant diameter dᵣ in a continuous tangent into the tooth profile of the main region. The respective main point is thereby consistent with the corresponding starting and end point of the Bézier curve. For the case where the main circle is selected so that it coincides with relevant diameter dᵣ, the two main points are positioned on main circle d_{H}. Otherwise the main points are positioned on relevant diameter dᵣ that is different from main circle d_{H}.

The advantages of the inventive solutions are as follows: Only one single continuous constant curve is now used that connects two successive tooth flanks with each other in the tooth root region. Since the Bézier curve constantly alters its curvature, no point is created where a curvature leap occurs. Thus no abrupt change in the tension progression in the tooth root region occurs. The tensions can therefore distribute themselves more uniformly and altogether more strung out.

The invention therefore offers a solution that permits optimum tension progression also when protuberances are provided. Even when protuberances are provided the tensions can distribute themselves more uniformly over the inventive tooth root region and thereby also altogether more strung out. The load capacity of the tooth root region is thereby considerably improved, even when a protuberance is present.

At the same time use of a Bézier curve allows for lower computing efforts in particular in the design of such a gearwheel. Due to the lower computing-intensive Bézier curve, optimizations of the preferred position of the main- and/or control points in regard to low root tensions can be considerably simplified. This is especially the case if the toothing is symmetrical, because then only one single parameter, namely the position of the one control point on the tangent through the main point, needs to be computed. The second control point that is required on the side opposite of the symmetrical axis is then simply mirrored according to its coordinates.

Use of the Bézier curves has the decisive advantage in regard to design and manufacture, that only two transition points, namely the continuous tangent transition in the region of the main points, have to be accordingly computed and defined. The remainder result directly from the Bézier curve so that a clear simplification can be achieved in the design of the toothing. The same does, however, offer very good load capacity that in each case is equal or in particular better than the load capacity of the toothing of the state-of-the-art described at the beginning.

The continuous tangent transition between the protuberance profile and the Bézier curve is especially preferably positioned from the tooth flank at a distance of one undercut F_{S}. Undercut F_{S} is understood by the expert to be that measurement—including a machining allowance such as the grinding allowance—that extends on the tooth flank of the main region parallel to the tooth flank up to the actual protuberance profile, in particular to the “deepest” point in the toothing of the protuberance profile, for example viewed in a circumferential direction.

It would thereby be conceivable that the at least two control points are positioned inside or outside a surface spanned by the tangents and the Bézier curve. This would however have the disadvantage of a discontinuous merge in the region of the main points, with losses of load capacity. The Bézier curve therefore includes preferably at least two control points, each of which are positioned in the tooth root region on the tangent at the main point. The main points that form the starting and end points of the continuous Bézier curve always coincide with the point at which the main region transitions into the tooth root region.

In one embodiment, the Bézier curve is a Bézier curve of the third or higher degree. It is in particular a cubic Bézier curve comprising precisely two control points, each of which is positioned on the tangent proceeding through the main point, whereby the distance k of each control point relative to its main point on the tangent is calculated as follows:

k=(0.25+0.1×f)×1

with:

0<k≦1 and 0≦f≦3,

whereby 1 stands for the distance of the one main point from intersection (S) of the tangents.

Factor f is preferably between 0.5 and 1.5.

The toothing can hereby be symmetrical or asymmetrical. In the first instance the tooth flanks of adjacent teeth located in the face section or normal section are designed symmetrical relative to each other, whereby the axis of symmetry intersects at the root point in the root circle and whereby the tangents proceed symmetrical to the axis of symmetry and—in the case of external toothing—intersect radially inside the relevant diameter in an intersection that is located on the axis of symmetry and in the case of internal toothing intersect radially outside the relevant diameter in an intersection that is located on the axis of symmetry. In an asymmetric embodiment of the toothing the tooth flanks of adjacent teeth in the face section or normal section are always designed asymmetrical relative to each other. The tangents intersect in an intersection that is not located on the axis of symmetry.

According to the described embodiments the Bézier curve can include a control polygon, whereby the entire control polygon that connects the main points as well as the at least two control points with each other is positioned inside the area spanned by the tangents and the Bézier curve.

The inventive toothing is suitable for straight, helical or curved toothing—such as spur gearing—in the tooth root region. The herewith associated increase in rigidity can also be achieved by toothing of, for example, bevel gears or other types of gears.

The inventive toothing is in particular conceivable for the design of the tooth root also for racks, bevel gears, beveloid gears, crown gears, helical gears or worm gears and various face gears, whereby the tooth root shape is then to be determined in the respective face section or normal section and whereby for example in the case of single- or multi-thread worm gears, based on the typically changing geometry of the tooth itself—for example the tooth height and tooth width—changes accordingly over the length of the entire tooth.

The inventive toothing can thus basically be used on different gearwheels and on elements that are equipped with teeth. The combination is thereby also conceivable with random tooth profiles in the main region and in particular in the main region and in particular in the useful region. Especially preferred, however, is the utilization with a main region and in particular in the useful region of a tooth profile in the embodiment of a rolling cam (involute and octoide), in particular an involute tooth profile. This conventional type of toothing that is generally used in mechanical engineering is especially suitable for the inventive arrangement of the tooth root region. The greatest load capacity increases due to the innovative arrangement of the tooth root region was determined on such involute toothed gearwheels.

In the case where the inventive toothing is provided for a toothed rack this toothing can be accordingly designed and then processed by means of a mating gearwheel that is meshing with the toothed rack. The aforementioned applies accordingly.

The appearance and the functionality of the new tooth root form is described below with reference to the drawings of design examples describing the example of a tooth gap of an involute externally toothed gearwheel in face section or normal section. As already described in detail, this arrangement of the tooth root region can also be used for various types of gearwheels and toothing, such as internal toothing.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates the parameters on an involute externally toothed gearwheel having spur gear toothing, shown in face section in two embodiments;

FIG. 2 illustrates the arrangement of the tooth root region on a gearwheel having symmetric toothing according to FIG. 1 consistent with the invention;

FIG. 3 illustrates the arrangement of the tooth root region on a gear having asymmetric toothing according to FIG. 1 consistent with the invention;

FIGS. 4a and 4b show two additional embodiments in a further development of the illustration in FIG. 1; and

FIG. 5 is a detailed illustration of toothing as illustrated in FIG. 1 or in FIG. 4b.

Corresponding reference characters indicate corresponding parts throughout the several views. The exemplifications set out herein illustrates embodiments of the invention, and such exemplifications are not to be construed as limiting the scope of the invention in any manner.

### DETAILED DESCRIPTION OF THE INVENTION

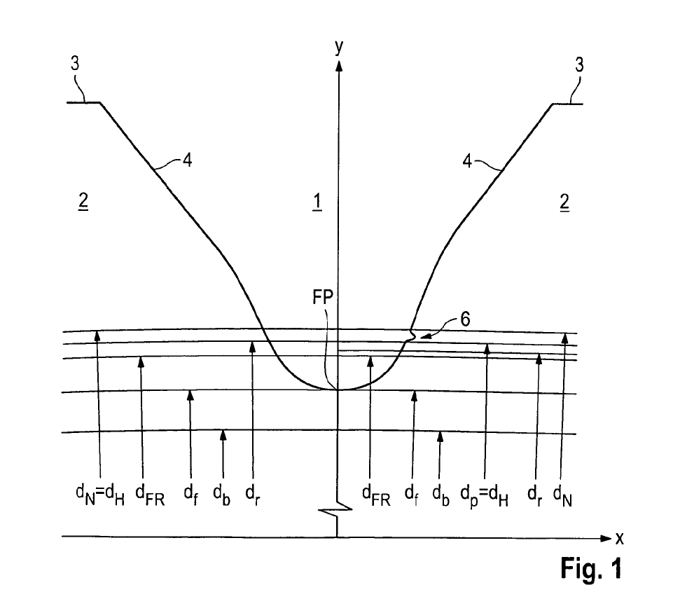

FIG. 1 illustrates the parameters on a tooth gap 1 for two embodiments in a partial face section, vertical to the non-illustrated axis of rotation of an externally toothed gearwheel—viewed in direction of the axis of rotation. The reference values are hereby the coordinates x, y, whereby the y-axis is at the same time the symmetrical axis of tooth gap 1. The x-axis or more precisely the origin of the illustrated x-y coordinate system shall thereby proceed through the non-illustrated rotational axis of the gearwheel. The illustration of FIG. 1 thereby shows on the left of the symmetry axis one design form whereby the inventive toothing has no protuberance. The illustration on the right of the symmetry axis in contrast shows a design form whereby a protuberance 6 is provided. The latter is exaggerated and not to scale.

The sections of the two teeth 2 indicated in the two illustrations are thereby restricted in their tip region 3 by a tip circle that is not illustrated. The tip circle may be consistent with the outside diameter of tip region 3. Tooth profile 4 that herein is selected as an example is an involute tooth flank shape that each time is used up to a diameter d_{N} of the so-called useful circle of the non-illustrated tooth flank of the tooth of a mating gearwheel or respectively gear element meshing with this gearwheel. In regard to both embodiments illustrated in FIG. 1, the section between the tip circle in the region of tips 3 of teeth 2 and a useful circle d_{N} is referred to in the following as “useful region”. Moreover, reference is also to be made to the diameter up to which a tooth of a mating gearwheel or respective tooth element meshing with this gearwheel engages into the tooth gap. This diameter is typically described as a free circle diameter d_{FR}. The region between useful circle d_{N} and the deepest point—that is the radially innermost point of tooth gap 1 in which the so-called root circle d_{f} is positioned, which in the case of the herein illustrated external toothing always adjoins in direction of the gearwheel center-is identified in the following text as the tooth root region of tooth gap 1. For the case that an internal toothing is provided, the region between useful circle d_{N} and the radially outermost point of tooth gap 1 adjoins free circle diameter d_{FR} in the direction away from the gearwheel center.

The intersection of symmetry axis y with root circle d_{F} is thereby root point FP of tooth gap 1.

The parameters described herein thus far are usual and common parameters on all gearwheels and will be relied on in the subsequent detailed description of the inventive arrangement of the tooth root region that herein is illustrated in the inventive manner.

In addition, additional parameters are significant for the herein described embodiments of the involute tooth profile 4. Thus, the so-called base circle d_{b} is drawn in FIG. 1 which is relevant for the design of tooth profile 4 of the involute toothing. Moreover, a brief reference should be made to module m that is commonly used in toothing and that results from the pitch diameter which is not illustrated here, divided by the number of teeth; or respectively, division p divided by factor π. Moreover, both embodiments of FIG. 1 show a main circle d_{H} which together with the tip circle defines a main region of the tooth profile. In the current example the main region directly adjoins the tooth root region. In the left side of the illustration in FIG. 1, the main region is consistent with the useful region. Main circle d_{H} and useful circle d_{N} therefore coincide with each other. In contrast, in the right side of the illustration, part of the main region in addition to the ancillary region is a protuberance region in which protuberance 6 is located. In this case the protuberance region proceeds between useful circle d_{N} and a protuberance circle d_{P} that is located radially internally opposite same. Accordingly, in the case of internal toothing, protuberance circle d_{P} would be positional radially outside useful circle d_{N}. In the current example, the main region is therefore limited in the radial direction toward the inside by main circle d_{H} which is consistent with protuberance circle d_{P}. Protuberance circle d_{P} can thereby pass through the radial innermost end of the protuberance profile which, for example, may be part of an arc. If internal toothing is provided the main region would therefore be limited similarly in the radial direction toward the outside by respective main circle d_{H}, so that protuberance circle d_{P} can pass accordingly through the radial outermost end of the protuberance profile.

Moreover, the diameter or respectively the radius can be recognized in FIG. 1 which is relevant for the invention and which is to be designated as relevant diameter dᵣ. In terms of the current invention, relevant diameter dᵣ—if it is imposed on main circle d_{H}—is consistent with the so-called form circle of conventional toothing. In the left side of the illustration in FIG. 1, relevant diameter dᵣ is selected from the arithmetic mean between useful circle diameter d_{N} and free circle diameter d_{FR}, so that a certain safety distance is created between relevant diameter dᵣ and useful circle diameter d_{N}. This ensures that a tooth (not illustrated here) of a mating gear element intermeshing with the gearwheel in each case runs off the calculated form of tooth flank 4—in this case the involute—and does not engage in a load bearing manner on the inventively designed shape of the flank in the tooth root region. In the right side of the illustration in FIG. 1, relevant diameter dᵣ is selected smaller in the current example than protuberance circle d_{P}. This also contributes to ensure a certain safety distance, in particular to protuberance 6. In the case of internal toothing the protuberance circle would be selected to be accordingly greater than the relevant diameter. This may be the case, but is not obligatory.

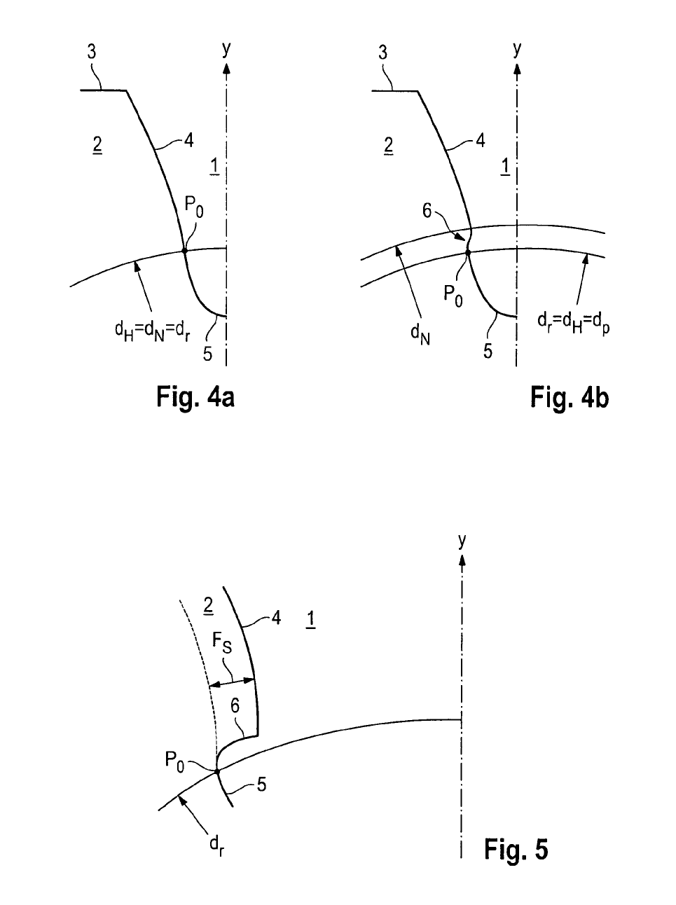

One alternative in the selection of the relevant diameter dᵣ according to FIG. 1 is illustrated in FIGS. 4a and 4b, in each case in a partial face section. Corresponding elements are identified with corresponding reference identifications. In FIG. 4a it can be seen that relevant diameter dᵣ coincides with main circle d_{H} and at the same time is consistent with useful circle d_{N}. In this case no protuberance is provided analog to the left side of the illustration in FIG. 1. Such a protuberance 6 is however illustrated greatly exaggerated and not to scale in FIG. 4b. In the current example it is located between useful circle d_{N} and relevant diameter dᵣ which, in this case coinciding with main circle d_{H} and at the same time with protuberance circle d_{P}.

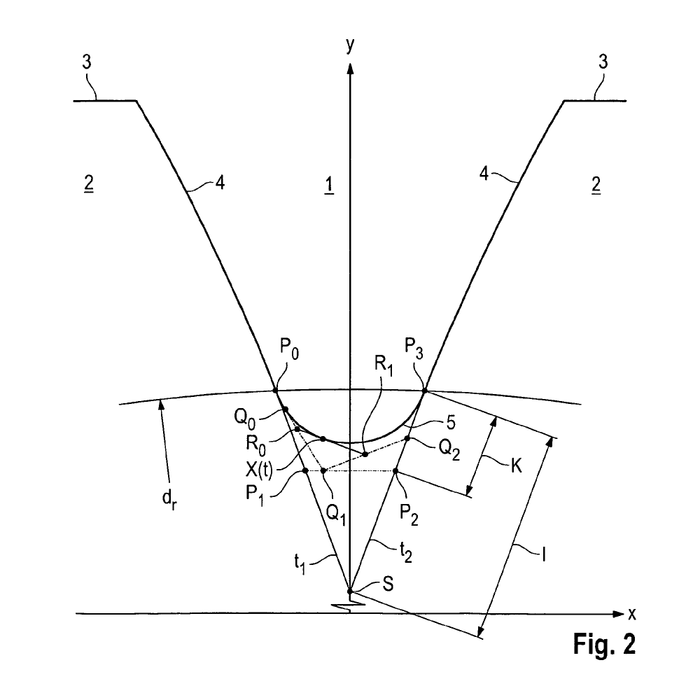

In FIG. 2 the shape of the tooth root is illustrated in one inventive arrangement of an example of external toothing, without protuberance. The illustrated toothing could also be implemented as internal toothing, with or without protuberances. The elements already referred to in FIG. 1 are identified also in FIG. 2 with the same references. Of the diameters discussed in FIG. 1 only relevant diameter dᵣ is now shown in FIG. 2. As already mentioned—due to safety and tolerance based reasons—tooth profile 4 of the useful region in the current design example merges in the region of relevant diameter dᵣ in a continuous tangent into the inventive arrangement of the tooth root form in the tooth root region. At points P₀ and P₃ which are also referred to as main points where diameter dᵣ intersects tooth profile 4, this transition occurs from involute tooth profile 4 into a Bézier curve 5.

According to the embodiment in FIG. 2 where the plane of symmetry of the illustrated and adjacent tooth flanks 4 proceeds perpendicular to the drawing plane through the y-axis, the tooth root region is also symmetrical to the plane of symmetry that proceeds through the y-axis.

Tangents t₁ and t₂ intersect at main points P₀ and P₃ at intersection point S on axis of symmetry y. In the current example control points P₁ and P₂ are located on tangents t₁, t₂. Near main points P₀ and P₃ additional control points Q₀ and Q₂ are positioned on tangents t₁ and t₂. One additional control point Q₁ is moreover provided. Control points Q₀, Q₁ and Q₂ respectively form the end points of the illustrated vertical dash-dot line. Control point Q₁ is thereby positioned on a double dash-dot line that connects control points P₁ and P₂. The respective main and control points in FIG. 2 are connected with each other and are identified as a control polygon. The latter is thereby position inside the area spanned by tangent t₁ and t₂ as well as Bézier curve 5.

Distance k of control points P1 and P2 from the corresponding main points P0 and P3 along the respective tangent t1 and t2 is thereby selected so that it is according to the following relationship:

k=(0.25+0.1×f)×1

with:

0<k≦1 and 0≦f≦3,

whereby 1 indicates the distance of the respective main point P₀, P₃ from intersection S of tangent t₁, t₂.

For construction of the Bézier curve—as it is illustrated in the remaining figures—one can proceed as previously discussed also as indicated in the remaining figures.

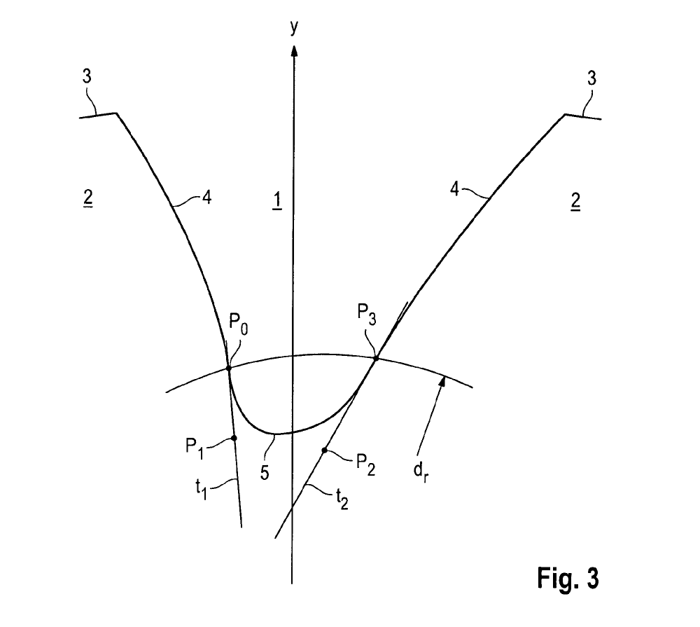

A comparative arrangement for an asymmetric external toothing can be seen in FIG. 3. Such an asymmetry is also conceivable for internal toothing. In each case a protuberance could also be provided, even though not illustrated. In the case of symmetric toothing, the y-axis that is illustrated herein as a dash-dot line would represent the symmetry axis analog to the y-axis in FIG. 2. Also, in the case of the asymmetric illustrated toothing, tooth profile 4 that in this case is arranged differently on the two sides of tooth gap 1 merges at the respective main points P₀, P₃ tangentially into Bézier curve 5. Control points P₁, P₂ are again positioned on these tangents t₁, t₂ which virtually continue the tangential transition in the main points P₀, P_{3,} in this case in a downward direction. An intersection S of tangents t₁, t₂ also occurs hereby in most cases; however, it is not located on the symmetry axis or respectively the y-axis, as can be seen from the illustration in FIG. 3, even though the intersection in this case is no longer within the illustration.

FIG. 5 is a detailed view of the toothing shown for example in the right side of the illustration in FIG. 1 or FIG. 4b. A continuous tangent transition between the protuberance profile and protuberance 6 in the main region and Bézier curve 5 in the tooth root region is seen in FIG. 5 in an example of an external toothing. The transition occurs herein in main point P₀ through which relevant diameter dᵣ proceeds. The transition is hereby located at a distance of one undercut F_{S} from tooth flank 2, measured parallel to the tooth flank. The same also applies to an accordingly designed internal toothing.

In principle, and independent of a specific embodiment illustrated in the drawings, Bézier curve 5 can be mathematically represented by means of the Bernstein polynomial:

$$\vec{X} ( t ) = {\sum }_{i = 0}^{n} ( \begin{matrix}n \\ i\end{matrix} ) {t}^{i} \cdot {( 1 - t )}^{n - i} \cdot {\vec{P}}_{i}$$

\vec{P}ᵢ are hereby the directional vectors to the support points (main- and control points)

$${\vec{P}}_{0} = ( \begin{matrix}{P}_{0 x} \\ {P}_{0 y} \\ 0\end{matrix} ) {\vec{P}}_{1} = ( \begin{matrix}{P}_{1 x} \\ {P}_{1 y} \\ 0\end{matrix} ) {\vec{P}}_{2} = ( \begin{matrix}{P}_{2 x} \\ {P}_{2 y} \\ 0\end{matrix} ) {\vec{P}}_{3} = ( \begin{matrix}{P}_{3 x} \\ {P}_{3 y} \\ 0\end{matrix} )$$

The following applies for cubic Bézier curves:

$$\vec{X} ( t ) = {\sum }_{i = 0}^{3} ( \begin{matrix}3 \\ 1\end{matrix} ) {t}^{i} \cdot {( 1 - t )}^{3 - i} \cdot {\vec{P}}_{i} = {( 1 - t )}^{3} \cdot {\vec{P}}_{0} + 3 {t ( 1 - t )}^{2} \cdot {\vec{P}}_{1} + 3 {t}^{2} ( 1 - t ) \cdot {\vec{P}}_{2} + {t}^{3} \cdot {\vec{P}}_{3} \\ \vec{X} ( t ) = ( - {\vec{P}}_{0} + 3 \cdot {\vec{P}}_{1} - 3 \cdot {\vec{P}}_{2} + {\vec{P}}_{3} ) \cdot {t}^{3} + ( 3 \cdot {\vec{P}}_{0} - 6 \cdot {\vec{P}}_{1} + 3 \cdot {\vec{P}}_{2} ) \cdot {t}^{2} + ( - 3 \cdot {\vec{P}}_{0} + 3 \cdot {\vec{P}}_{1} ) \cdot t + {\vec{P}}_{0}$$

With the introduction of the vectorial factors the following applies:

\vec{D}=−\vec{P}₀+3·\vec{P}₁−3·\vec{P}₂+\vec{P}₃

\vec{C}=3·\vec{P}₀−6·\vec{P}₁+3·\vec{P}₂

\vec{B}=−3·\vec{P}₀+3·\vec{P}₁

\vec{A}=\vec{P}₀

Resulting thus in the parameter shape of the Bézier curve:

\vec{X}(t)=\vec{D}·t³+\vec{C}·t²+\vec{B}·t+\vec{A}

If all points \vec{X} for t∈[0;1] are calculated, then the Bézier curve results between \vec{P}₀ and \vec{P}₃ with control points \vec{P}₁ and \vec{P}₂.

One specific example for a symmetric toothing of a gearwheel pair by way of values that are selected from the aforementioned value ranges is explained below. The selected identifications and formula symbols are those that are commonly used and recognized.

A gearwheel toothed according to one embodiment and its mating gearwheel can for example have the following parameters:
Gearwheel: 1
Module: 4
Number of teeth: 50
Pressure angle: 20°
Addendum modification coefficient: 0.2
Mating gearwheel: 2
Module: 4
Number of teeth: 35
Pressure angle: 20°
Addendum modification coefficient: 0.321
Distance from axis: 172 mm
Comparison: Toothing according to DIN 867
Hobbed fillet contour without protuberance
tip height factor h_{aP0}=1.389
tip rounding factor ρ_{aP0}=0.25
Tool-machining allowance, in other words finishing: 0.0
(* indicates: module dependent)
Useful circle diameter: dₙ₁=195.617 mm
Root circle diameter: d_{f1}=189.79 mm
Transition diameter involute Bézier curve; this is consistent with the relevant diameter dᵣ: d_{ü1}=193.48 mm

From this data the transition point from the useful region to the tooth root region of the toothing can be easily determined with the coordination system origination in the center of the gearwheel with the tooth gap center on the y-axis.

Pressure angle at the transition diameter: a_{ü}=14.796°

Only the control point is still missing for determining the Bézier curve. On the transition diameter the transition point—here identified as main point P₀ or P₃—is defined on the left as well as on the right flank (in the case of symmetric toothing symmetrical to the y-axis). A tangent t₁, t₂ is applied to the involute at both main points. The intersection of tangent t₁, t₂ applied to the left flank with that to the right flank results in intersection S.

The two control points P₁ and P₂ can now theoretically be positioned on each point of the straight P̅ₒ̅S̅ or P̅₃̅S̅ whereby the variable k∈[0; 1] is defined.

After determining the points, a cubic equation is developed in vector style with the Bernstein polynomial:

\vec{X}(t)=\vec{D}·t³+\vec{C}·t²+B·t+\vec{A}

With:

$$D = ( \begin{matrix}- 3.578 \\ 0\end{matrix} )$$

$$C = ( \begin{matrix}5.368 \\ 6.639\end{matrix} )$$

$$B = ( \begin{matrix}1.754 \\ - 6.639\end{matrix} )$$

$$A = ( \begin{matrix}- 1.771 \\ 96.724\end{matrix} )$$

This now creates the Bézier curve.

As a result, an improvement of approximately 35% compared to conventional toothing is achieved with this calculation, in addition to a calculation saving of up to 25 calculations compared with the toothing mentioned at the beginning with tangent function and arc.

The production of such gearwheels can occur for example by means of milling or grinding machines that are freely movable in several axes and are freely programmable, or by way of suitable hobbing cutters that are derived from the inventive tooth root form.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A toothing of a gearwheel having a plurality of teeth, said toothing comprising tooth flanks including a main region and a tooth root region; whereby, when considered in a cross section:
said tooth root region extends from a root circle as far as a main circle (d_{H}) through the axis of rotation of the gearwheel;
said tooth flanks in said tooth root region are designed as a Bézier curve starting from a relevant diameter (dᵣ) in the direction toward the root circle; and
said Bézier curve merges in each case at a main point (P₀, P₃) in said relevant diameter (dᵣ) in a continuous tangent into the tooth profile of said main region.

2. The toothing according to claim 1, wherein the relevant diameter (dᵣ) coincides with the main circle (d_{H}).

3. The toothing according to claim 1, wherein the Bézier curve includes at least two control points (P₁, P₂), each of which are positioned in the tooth root region on a tangent (t₁, t₂) at a main point (P₀, P₃).

4. The toothing according to claim 1, wherein the Bézier curve is a Bézier curve of the third or higher degree, in particular a cubic Bézier curve including precisely two control points (P₁, P₂), each of which is positioned on a tangent (t₁, t₂) proceeding through a main point (P₀, P₃), whereby the distance (k) of each control point (P₁, P₂) relative to its main point (P₀, P₃) on a tangent (t₁, t₂) is calculated as follows:
k=(0.25+0.1×f)×1
with:
0<k≦1 and 0≦f≦3,
whereby 1 represents the distance of the one main point (P0, P3) from the intersection (S) of the tangents (t₁, t₂).

5. The toothing according to claim 4, wherein the factor f is preferably between 0.5 and 1.5.

6. The toothing according to claim 1, wherein the tooth flanks of adjacent teeth located in the face section or normal section are designed symmetrical relative to each other, whereby the axis of symmetry (y) intersects at the root point in the root circle; and whereby the tangents (t₁, t₂) proceed symmetrical to the axis of symmetry (y) and, in the case of external toothing, intersect radially inside the relevant diameter (dᵣ) in an intersection (S).

7. The toothing according to claim 1, wherein the tooth flanks of adjacent teeth located in the face section or normal section are always designed asymmetrical relative to each other.

8. The toothing according to claim 1, wherein the Bézier curve includes a control polygon, whereby the entire control polygon that connects main points (P₀,P₃) as well as the at least two control points (P₁, P₂) with each other is positioned inside the area spanned by tangents (t₁, t₂) and the Bézier curve.
